(19) United States
(12) Patent Application Publication
(10) Pub. No.: US 2016/0168891 A1
(43) Pub. Date: Jun. 16, 2016

(54) DOOR LATCH SYSTEM WITH INTEGRATED MAGNET

(71) Applicant: LIPPERT COMPONENTS, INC., Elkhart, IN (US)

(72) Inventors: Scott C. McKINNON, Union City, MI (US); Dallas M. MARTIN, Sawyer, MI (US); David Wysong, Goshen, IN (US)

(21) Appl. No.: 14/954,038

(22) Filed: Nov. 30, 2015

Related U.S. Application Data
(60) Provisional application No. 62/207,185, filed on Aug. 19, 2015.
(60) Provisional application No. 62/091,163, filed on Dec. 12, 2014.

(51) Int. Cl. E05C 17/56

(52) U.S. Cl. CPC E05C 17/56

(57) ABSTRACT

A door latch includes an integral magnet. The door latch may be installed in a door panel. The door panel maybe pivotably connected to a sidewall of a structure. A magnetic coupler may be attached to the sidewall at a location complementary to the location of the magnet when the door panel is opened and the door latch abuts the sidewall. With the door panel opened and the latch abutting the sidewall, the magnetic field between the magnet and magnetic coupler maintain the door in the open position.

### CROSS-REFERENCE TO RELATED APPLICATIONS

This application claims benefit under 35 U.S.C. §119 of U.S. Provisional Patent Application No. 62/091,163, filed on Dec. 12, 2014, and U.S. Provisional Patent Application No. 62/207,185, filed on Aug. 19, 2015, and incorporates by reference the disclosures thereof in their entireties.

### BACKGROUND OF THE DISCLOSURE

Buses, recreational vehicles, and the like often include externally accessible storage compartments. The storage compartments may be accessible by means of a top-hinged door. The door may be secured when in the closed position using a latch. Securing the door in the open position is another issue.

### BRIEF DESCRIPTION OF THE DRAWINGS

FIG. 1 is a perspective view of an illustrative door latch with integrated magnet;

FIG. 2 is a front elevation view of the illustrative door latch of FIG. 1;

FIG. 3 is a side cross-sectional view of the illustrative door latch of FIG. 1 installed in a door panel, which is installed in a side wall of a structure, with the door panel in a closed and latched position;

FIG. 4 is a side cross-sectional view of the illustrative door latch of FIG. 1 installed in a door panel, which is installed in a side wall of a structure, with the door panel in an open and magnetically secured position;

FIG. 5 is a front elevation view of an alternative illustrative door latch with integrated magnet;

FIG. 6 is a side elevation view of the alternative illustrative door latch of FIG. 5;

FIG. 7 is a side cross-sectional view of the illustrative door latch of FIGS. 5 and 6 installed in a door panel, which is installed in a side wall of a structure, with the door panel in a closed and latched position;

FIG. 8 is a side cross-sectional view of the illustrative door latch of FIGS. 5 and 6 installed in a door panel, which is installed in a side wall of a structure, with the door panel in an open and magnetically secured position;

FIG. 9 is a front elevation view of the illustrative door latch of FIGS. 5 and 6 installed in a door panel, which is installed in a side wall of a structure, with the door panel in a closed position;

FIG. 10A is a detail view of the door latch of FIGS. 5 and 6 engaged with a magnetic coupler associated with the side wall of the structure; and

FIG. 10B is front elevation view of the door latch of FIGS. 5 and 6 engaged with the magnetic coupler associated with the side wall of the structure as viewed from the side wall of the structure.

### DETAILED DESCRIPTION OF THE DRAWINGS

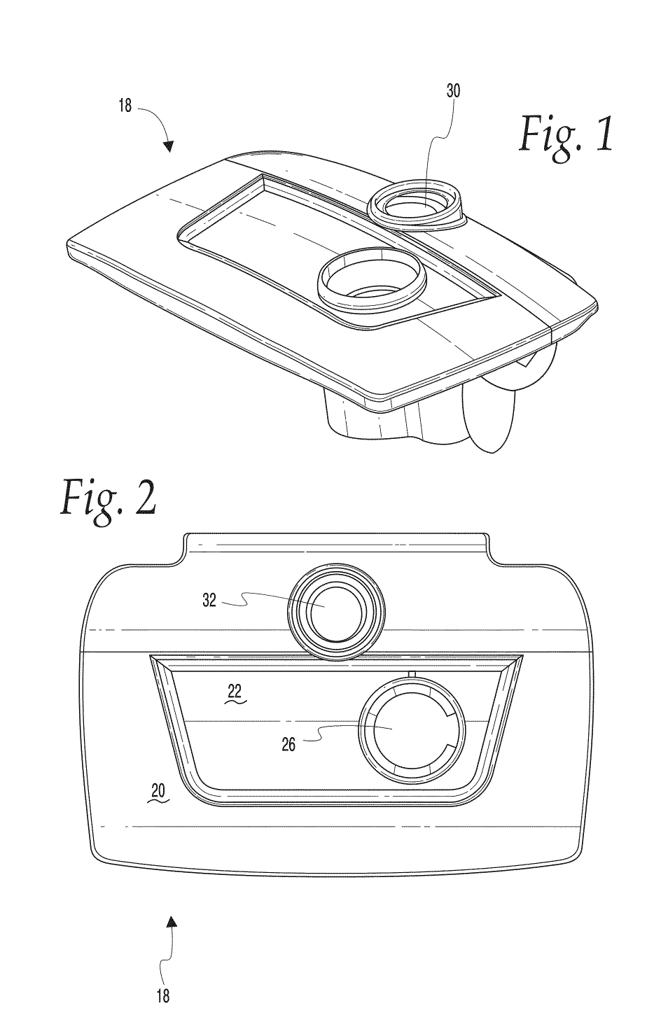

FIGS. 1-4 show an illustrative embodiment of a door latch system with integrated magnet 10. The system 10 includes a door panel 12 pivotably connected via a hinge 14 to a sidewall 16 of a structure, for example a bus or recreational vehicle.

A door latch 18 is installed in the door panel 12 proximate an edge thereof opposite the hinge 14. The door latch 18 includes a body 20, a paddle 22 pivotably connected to the body 20, and a bolt 24 operated by the pivoting of the paddle relative to the body. The paddle 22 may include a recess 26 configured to receive a lock cylinder 28. The paddle 22 may include a recess 30 configured to securely receive a magnet 32 via adhesive, interference fit or other means. In other embodiments, the magnet 32 may be molded into the paddle 22 or disposed on an inner surface of the paddle. In further embodiments, the magnet 32 may be located on other parts of the door latch 18. Such other parts of the door latch 18 could include a recess similar to recess 30 configured to securely receive the magnet 32.

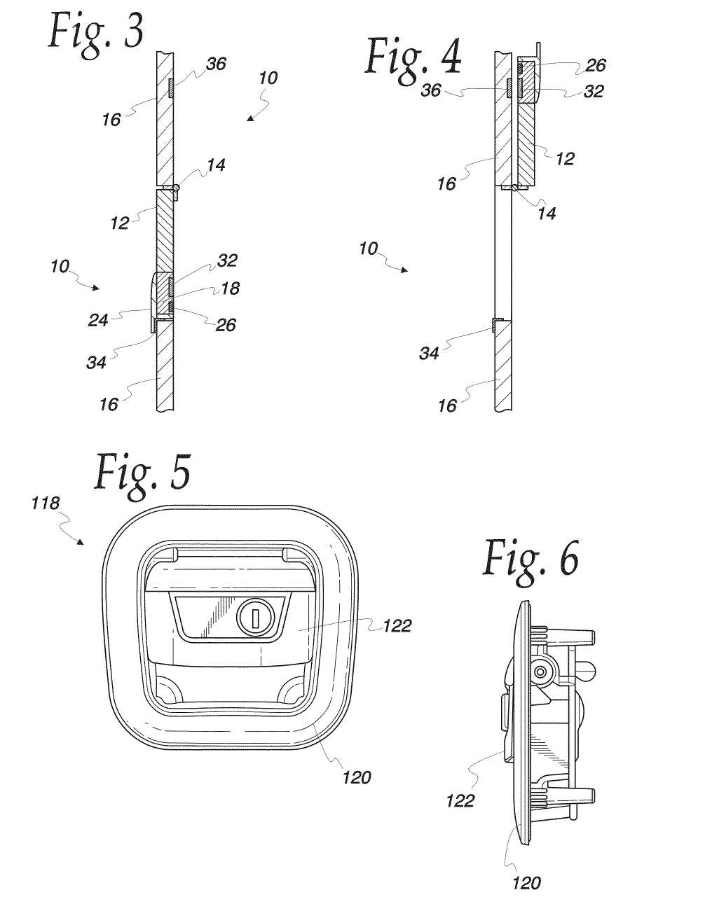

When the door panel 12 is in the closed position, as shown in FIG. 3, the bolt 24 may engage with a corresponding strike 34 in or on or about the sill of the opening in which the door panel is disposed. When the door panel 12 is fully opened, as shown in FIG. 4, the magnet 32 magnetically couples with a corresponding magnetic coupler 36 embedded in or otherwise secured to the sidewall 16. The magnetic coupler 36 could be another magnet or a piece of ferromagnetic material. The magnetic coupler 36 is shown as a discrete component embedded in the sidewall 16 and having a shape and size complementary to the magnet 32. In other embodiments, the magnetic coupler 36 could be larger or smaller than the magnet 32 and shaped differently. Also, the magnetic coupler 36 could be associated with the sidewall 16 in different ways. For example, the magnetic coupler 36 could be a ferromagnetic plate attached to or embedded in an interior or exterior surface of the sidewall 16. In an embodiment, the magnetic coupler 36 could be a magnet, and a piece of ferromagnetic material could replace magnet 32.

In the foregoing embodiments, the structures carrying the magnet 32 and the magnetic coupler 36, for example, the door latch 18 and the sidewall 16, could be made of non-ferromagnetic material.

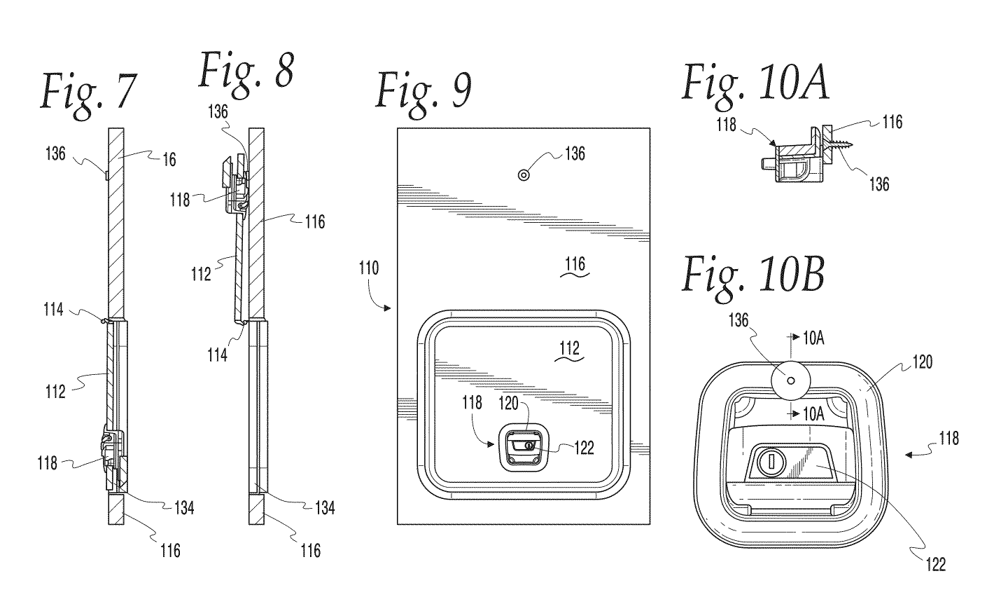

FIGS. 5-10B show another illustrative embodiment of a door latch system 110. Door latch system 110 is similar to door latch system 10, except that door latch system 110 lacks the discrete magnet 32 and recess 30 for holding the magnet 32. Instead, in door latch system 110, at least a portion of the door latch 118 itself may be magnetized. For example, without limitation, a portion or the entirety of the body 120 and/or the paddle 122 of the door latch 118 could be magnetized. When the door panel 112 is fully opened, the magnetized portion(s) of the door latch 118 could magnetically couple with the magnetic coupler 136.

Similarly, the sidewall 116 itself or a portion thereof could be made of ferromagnetic material and the discrete magnetic coupler 136 could be omitted. In such an embodiment, the magnetized portion(s) of the door latch 118 could magnetically couple with such portion of the sidewall 116 when the door 112 is fully open, as shown in FIG. 8.

In an embodiment, the sidewall 116 or a relevant portion thereof could be magnetized and at least a portion of the door latch 118 could be made of a non-magnetized ferromagnetic material so that the door latch and sidewall can become magnetically coupled when the door is fully open.

In another embodiment, at least a portion of each of the door handle 118 and sidewall 116 could be magnetized so that the door latch and sidewall can become magnetically coupled when the door is fully open.

In a further embodiment, the magnetic coupler 136 may be magnetized and a ferromagnetic plate or other ferromagnetic structure may be disposed behind the door latch 118. For example, such a ferromagnetic plate or other ferromagnetic structure may be adhered or otherwise attached to the rear of the door latch 118. The ferromagnetic plate or other ferromagnetic structure could, but need not, be magnetized. In this embodiment, the door latch 118 could be made of a non-ferromagnetic material.

1. A system comprising:
a wall defining an opening therein;
a door panel configured to cover or substantially fill said opening;
a hinge having a hinge axis, said hinge disposed between said wall and said door panel;
a latch attached to said door panel, said latch comprising a magnetized portion located at a first predetermined distance perpendicular to said hinge axis; and
a magnetic coupler associated with said wall at a second predetermined distance perpendicular to said hinge axis;
wherein said door panel is pivotable about said hinge axis between a first position wherein said door panel covers or substantially fills said opening, and a second position wherein said magnetized portion magnetically couples with said magnetic coupler with sufficient magnetic force to maintain said door panel in said second position in the absence of a non-gravitational, external force.

2. The system of claim 1 wherein said first predetermined distance is substantially equal to said second predetermined distance.

3. The system of claim 1, said hinge connected to said wall and to said door panel.

4. The system of claim 1 further comprising a door frame disposed between said hinge and said wall.

5. The system of claim 4, said hinge connected to said door panel and to said door frame.

6. The system of claim 1, said magnetized portion of said latch comprising a discrete magnet attached to said latch.

7. The system of claim 1, said latch comprising a body and a paddle.

8. The system of claim 7, wherein at least one of said body and said paddle is magnetized.

9. The system of claim 7, said magnetized portion of said latch comprising at least one discrete magnet attached to at least one of said body and said paddle.

10. The system of claim 1, said magnetic coupler comprising a ferromagnetic member attached to said wall.

11. The system of claim 10 wherein said ferromagnetic member is magnetized.

12. The system of claim 10, said magnetic coupler attached to an outer surface of said wall.

13. The system of claim 10, said magnetic coupler attached to an inner surface of said wall.

14. The system of claim 10, said magnetic coupler disposed between an inner surface of said wall and an outer surface of said wall.

15. The system of claim 1, at least a portion of said wall comprising a ferromagnetic material, said at least a portion of said wall comprising said magnetic coupler.

16. A door comprising:
a door panel; and
a latch attached to said door panel, said latch comprising a magnetized portion.

17. The door of claim 16, said magnetized portion of said latch comprising a discrete magnet attached to said latch.

18. The door of claim 16, said latch comprising a body and a paddle.

19. The door of claim 18, wherein at least one of said body and said paddle is magnetized.

20. The door of claim 18, said magnetized portion of said latch comprising at least one discrete magnet attached to at least one of said body and said paddle.
